(19) United States
(12) Patent Application Publication
(10) Pub. No.: US 2012/0125845 A1
(43) Pub. Date: May 24, 2012

(54) DEVICE AND IMPLEMENTATION FOR SANITIZING A FLUID-DISPENSING APPLIANCE

(76) Inventors: Neil K. MCDONALD, Georgetown, IN (US); Daniel Ryan Capelle, Corvdon, IN (US); Mark Anthony Copelli, Flovds Knobs, IN (US)

(21) Appl. No.: 12/953,777

(22) Filed: Nov. 24, 2010

(51) Int. Cl. B01D 65/02

(52) U.S. Cl. 210/636

(57) ABSTRACT

An appliance such as a water dispenser is described that is configurable between a sanitation configuration and a filtering configuration. In one embodiment, the appliance comprises a fluid treatment assembly with an interface for receiving a treatment media such as a sanitizing media and a filtering media. One or more of the sanitizing media and the filtering media can be disposed in a treatment cartridge, the treatment cartridge being configured to engage the interface and to place in fluid communication the contents of the cartridge and a fluid that flows in the appliance.

### BACKGROUND OF THE INVENTION

The subject matter disclosed herein relates generally to appliances, and more particularly to embodiments of an appliance configured to dispense a fluid (e.g., water) in a sanitation configuration and a filter configuration.

Household appliances that dispense liquids are available in various platforms that have different configurations of structural features, operational features, and controls. For example, water cooler platforms may include side-by-side dispensers, which can dispense liquid from both vertically-oriented containers (e.g., water bottles) and municipal supplies. These platforms are often equipped with a refrigeration unit and a water heater, which permit hot and cold liquid to be dispensed from a single platform.

These platforms can also include filtration systems, many of which are commonly designed for use in the home, such as refrigerator-based systems and under-sink systems. Because filtration systems are useful to remove contaminants from liquids, and due to increasing quality and health concerns with regard to municipal and well-water supplies, the popularity of such filtrations systems has increased markedly. For example, filtration systems in water coolers and other appliances that dispense liquids, once considered a luxury feature, are now included as a standard feature in all but entry-level designs.

At least some conventional filtration systems include filters that can remove elements such as carbon, lead, mercury, bacteria, and sediment (e.g., polyspun) from liquids that flow through the filler. Such filters typically have a limited life-span and must be changed after a determined period of time. Changing the filter from the filtration system often requires removing and replacing the filter.

Less prevalent in water dispensers, however, are adequate means to clean and sanitize the interior components such as the tubing, valves, and related components through which flows the liquid. These components are, however, susceptible to contamination. Bacterial colonies, fungus, and related contaminants that can impart taste and odor into the liquid can build-up as a result of the intermittent use of the water dispenser.

It would therefore be advantageous to provide an appliance for dispensing a fluid with a sanitation feature, and even more advantageous to incorporate the sanitation feature into the filtration system.

### BRIEF DESCRIPTION OF THE INVENTION

As discussed in more detail below, the inventors have developed concepts that, when implemented in connection with an appliance such as point-of-use (“POU”) water dispenser, permit filtration and sanitation of the dispenser without the need to decouple the appliance from its water supply. In this connection, the concepts are compatible with various types of appliances such as household appliances (e.g., water coolers and refrigerators), as well as other types of fluid-carrying devices that are susceptible to contamination and therefore require periodic cleansing and sanitation. While discussed in terms of POU water dispensers that are coupled to municipal water supplies, the concepts of the present disclosure are relevant to any of these other types of appliances.

Further discussion of these concepts, briefly outlined above, is provided below in connection with one or more embodiments.

In one embodiment, an appliance for dispensing a fluid comprises a fluid inlet, a fluid outlet coupled to the fluid inlet, and a fluid treatment assembly in fluid communication with the fluid inlet and the fluid outlet, the fluid treatment assembly comprising an interface. In one example, the interface is configured to receive a treatment media, which is interchangeable between at least one of a sanitizing media and a filtering media.

In another embodiment, an appliance has a fluid inlet, a fluid outlet, and a fluid transport system that communicates a fluid between the fluid inlet and the fluid outlet. The appliance comprises a manifold and a cartridge interface coupled to the manifold. In one example, the cartridge interface is interchangeable between a sanitation configuration and a filtering configuration.

### BRIEF DESCRIPTION OF THE DRAWINGS

Reference is now made briefly to the accompanying drawings, in which:

FIG. 1 is a schematic diagram of an exemplary embodiment of an appliance for dispensing a fluid.

FIG. 2 is a schematic diagram of another exemplary embodiment of an appliance for dispensing a fluid.

FIG. 3 is a schematic diagram of yet another exemplary embodiment of an appliance for dispensing a fluid.

FIG. 4 is a side, perspective, partial broken view of a water dispenser embodying one or more of the concepts of the present disclosure, such as the concepts related to the appliances of FIGS. 1-3.

FIG. 5 is a schematic diagram of an example of a control configuration for use with an appliance such as the appliances of FIGS. 1-4.

Where applicable like reference characters designate identical or corresponding components and units throughout the several views, which are not to scale unless otherwise indicated.

### DETAILED DESCRIPTION OF THE INVENTION

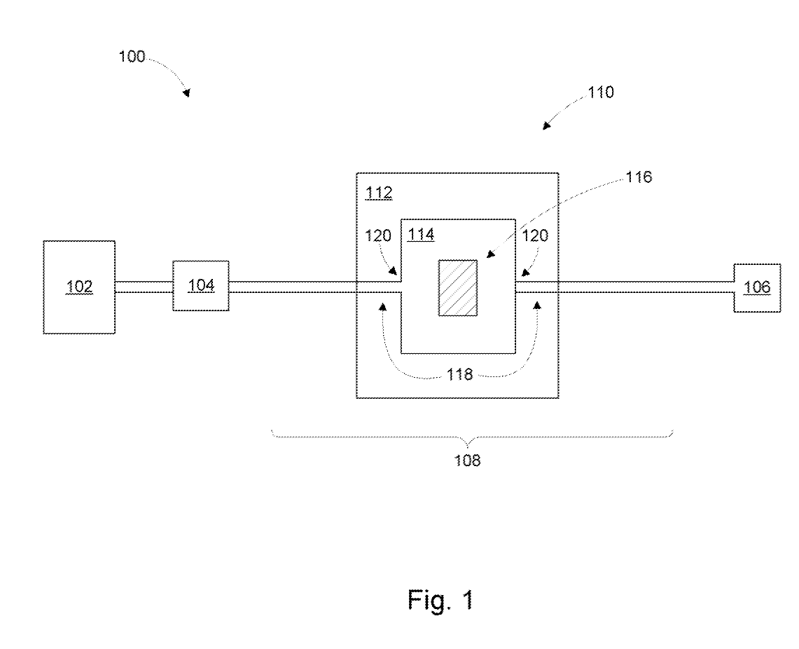

By way of example, and with reference now to the schematic diagram of FIG. 1, there is depicted an exemplary embodiment of an appliance 100. The appliance 100 is configured for the flow of fluid from a fluid supply 102 such as a water bottle and/or municipal or well water supply that provides water service to a premise (e.g., a house, an apartment, and an office building). The appliance 100 includes a fluid inlet 104, which is coupled to the fluid supply 102, and a fluid outlet 106 that receives fluid from the fluid inlet 104 such as by way of a fluid transport system 108.

In one embodiment, the fluid transport system 108 includes a fluid treatment assembly 110 with an interface 112 in which is disposed a treatment element 114. The treatment element 114 comprises a treatment media 116, which is useful for cleaning, disinfecting, and sanitizing portions of the appliance 100 and for filtering the fluid as the fluid passes from the fluid inlet 104 to the fluid outlet 106. The fluid treatment assembly 110 also includes a fluid passage 118 with openings 120 coupled to the interface 112.

At a high level, details being provided in the discussion of the embodiments below, the fluid treatment assembly 110 is configurable for one or more treatment configurations including a sanitation configuration and a filtering configuration. In one embodiment, the treatment element 114 is provided as one or more discrete components, wherein the treatment media 116 in each of the discrete components effectuates the treatment configuration that is selected. For the sanitation configuration, the treatment media 116 has properties that effectuate cleaning and sanitization of, for example, the fluid transport system 108. Likewise for the filtering configuration, the treatment media 116 has properties to filter the fluid, and more particularly to filter the fluid before the fluid exits to the fluid outlet 106.

Changes between and among the treatment configurations is facilitated by the construction of the fluid treatment assembly 110. In one embodiment, the treatment element 114 is interchangeable within the fluid treatment assembly 110, and more particularly the treatment element 114 is removably replaceable from the interface 112. This interchangeability exposes in fluid communication the fluid to different types of the treatment media 116 such as the filtering media and the sanitizing media mentioned above. When discrete components are used for the treatment element 114, for example, a first treatment element that is configured with a filtering media can be exchanged with a second treatment element that is configured with a sanitizing media.

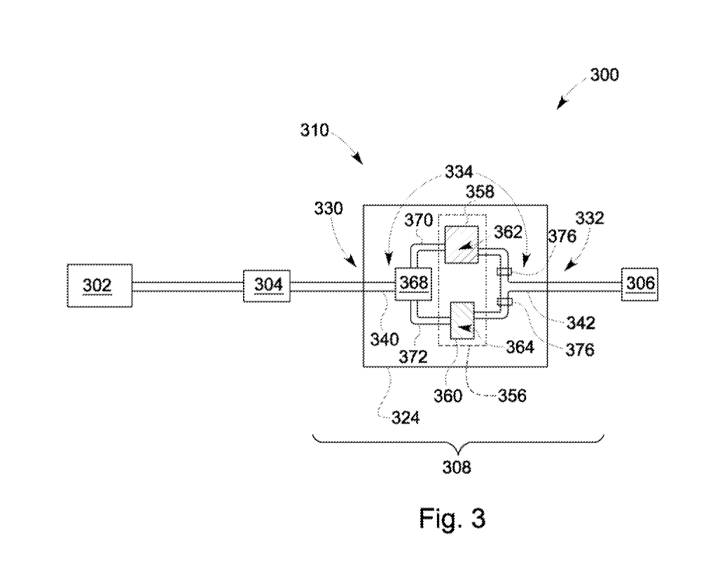

In another embodiment, the interface 112 includes separate locations for the first treatment element and the second treatment element. The separate locations communicate with the fluid inlet 104 and the fluid outlet 106 by way of the fluid transport system 108. The treatment configurations can thereafter be operatively selected by directing the fluid to the location of the treatment media 116 that is consistent with, e.g., the sanitation configuration and the filtering configuration. In yet another embodiment, the treatment element 114 is incorporated into the interface 112 such as by providing an area (e.g., a fluid reservoir) of the fluid treatment assembly 110 for the sanitizing media and an area of the fluid treatment assembly 110 for the filtering media. Each of the areas is equipped for fluid to flow in communication with the treatment media 116. A discussion of an exemplary appliance 300 that is equipped with this area and/or fluid reservoir is provided in connection with FIG. 3 below.

To facilitate interchangeability in one embodiment of the appliance 100, the interface 112 and the treatment element 114 are configured to engage one another. This engagement permits fluid to communicate with the treatment media 116. Various devices and mechanisms are contemplated to effectuate the engagement including, but not limited to, complimentary threads and locking features on each of the interface 112 and the treatment element 114. Other types of fasteners can also be incorporated into one or more of the interface 112, the treatment element 114, and the fluid treatment assembly 110 in general. In one embodiment, the mechanism is a twist-and-lock feature, in which a portion of the treatment element 114 is disposed in a portion of the interface 112. The treatment element 114 is rotated to engage the interface 112 and expose the treatment media 116 to the fluid.

Different types of the treatment media 116 are used to configure the treatment element 114 such as for one or more of the treatment configurations, e.g., the sanitation configuration and/or the filtering configuration. Each type of treatment media 116 can have different functions and/or characteristics suited for the specific configuration. Filtering configurations can include, for example, particle filtering, taste and odor removal filtering, lead and mercury removal filtering, and combinations thereof. Sanitation configurations, which remove contaminants from the appliance 100, can be targeted at specific agents, e.g., bacteria or fungus, as well as broadly directed to remove agents, and to clean and sanitize the elements of the fluid transport system 108 and the appliance 100 in general.

The treatment media 116 include materials of various forms and structures such as fluids (e.g., liquids) and solids (e.g., powders). Exemplary materials include bleach and bleach-derivatives. However, other materials are contemplated that have properties compatible with sanitizing the appliance 100. To effectuate cleaning of the appliance 100, the material is diluted such as in water or other fluid to form a cleaning solution, which is of appropriate viscosity so as to flow through the fluid transport system 108. In one embodiment, fluid from the fluid supply 102 is used to flush the cleaning solution from the treatment element 114, through the fluid transport system 108, and out of the fluid outlet 106.

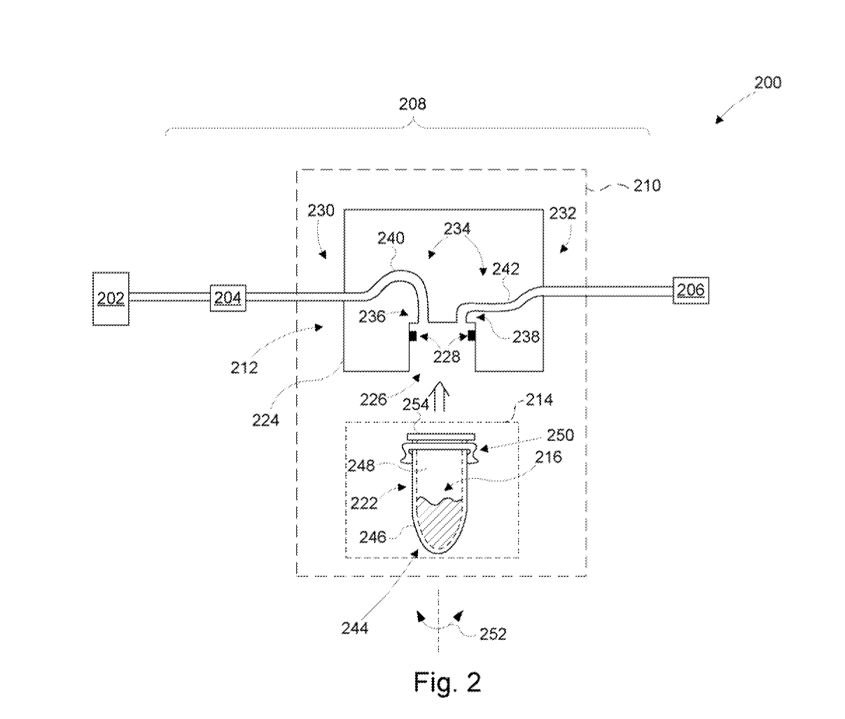

Continuing with the discussion of these concepts, broadly outlined above, reference is now turned to FIG. 2 and the exemplary embodiment of an appliance 200 that is depicted therein. Like numerals are used to identify like components as between FIG. 1 and FIG. 2, but the numerals are increased (e.g., 100 in FIG. 1 is 200 in FIG. 2). For example, the appliance 200 is coupled to a fluid supply 202, and includes a fluid inlet 204, a fluid outlet 206, a fluid transport system 208, and a fluid treatment assembly 210.

The fluid treatment assembly 210 includes an interface 212 and a treatment element 214 with a treatment media 216 disposed in a treatment cartridge 222. In one embodiment, the interface 212 comprises a manifold 224 and a cartridge interface 226, which is coupled to the manifold 224 and is for receiving the treatment cartridge 222 therein. In one example, the cartridge interface 226 comprises a locking mechanism 228, which is used to secure and retain the treatment cartridge 222 to the manifold 224.

The manifold 224 has an inlet side 230 and an outlet side 232. A fluid passage 234 permits fluid to flow through an inlet opening 236, which is upstream of the treatment element 214, to an outlet opening 238, which is downstream of the treatment element 214. As depicted in FIG. 2, the fluid passage 234 includes an inlet portion 240 and an outlet portion 242, both of which terminate at or around the cartridge interface 226. As discussed below, engagement of the treatment cartridge 222 and the manifold 224 places in fluid communication the interior of the treatment cartridge 222 with the inlet portion 240 and the outlet portion 242.

The treatment cartridge 222 comprises a vessel, generally identified by the numeral 244, with a wall 246 that forms an interior cavity 248 for holding the treatment media 216. The vessel 244 includes a vessel interface 250 with features selected to engage the cartridge interface 226 generally, and in this particular example the vessel interface 250 has features complimentary to the locking mechanism 228 so that rotation 252 of the vessel 244 engages and disengages the vessel interface 250 and the locking mechanism 228. In one embodiment, the vessel 244 also includes a cap 254, which is secured to the vessel 244. The cap 254 is configured to control access to the interior cavity 248, thereby retaining the treatment media 216 inside the interior cavity 248 until engagement of the treatment cartridge 222 and the cartridge interface 226.

The cartridge interface 226 is interchangeable between the sanitation configuration and the filtering configuration discussed above. In one implementation, insertion of the treatment cartridge 222 into the cartridge interface 226 places the treatment media 216 in fluid communication with the inlet portion 240 and the outlet portion 242. This communication permits fluid to flow into the interior cavity 248, and in one particular construction the fluid dilutes the treatment media 216 and carries the treatment media 216, in diluted form, throughout the fluid transport system 208.

The vessel 244 is constructed of materials compatible with the treatment media 216, with exemplary materials comprised of metals, plastics, composites, and other materials consistent with consumer consumables. These materials can be shaped into the elongated cylindrical vessel depicted in FIG. 2 or into other shapes (e.g. a sphere or a cube) that are useful for holding and retaining fluid therein. The vessel 244 and the cap 254 can be formed as separate pieces, which are assembled together for permanent and/or releasable engagement of the pieces. Integral construction of the body of the vessel 244 and the cap 254 is also contemplated. In either construction, access to the interior cavity 248 is provided via an aperture (not shown) such as a fill spout that can be used to prepare the treatment media 216 as discussed below.

For the sanitation configuration of the appliance 200, the treatment media 216 includes a cleaning solution that is disposed in the vessel 244. The cleaning solution can comprise a sanitizing agent such as bleach, soap, or other material suited for cleaning and sanitizing the components of the appliance 200. The sanitizing agent, which is in fluid or solid form such as liquid and/or powdered bleach, is disposed into the vessel 244. In one embodiment, a dilution agent such as water is also disposed in the vessel 244, thereby diluting and/or dissolving the sanitizing agent.

For the filtration configuration of the appliance 200, the treatment media 216 comprises a filter medium, which can include particular material and constructive components that are housed in the vessel 244. The filtering medium facilitates removal of impurities from fluid in the appliance 200. Such impurities included, but not limited to, sediment, taste, odor, lead, mercury, bacteria, and/or viruses. Filtering media for removal of such impurities are well known in the art and include, for example, pleated paper, carbon particle, carbon block, poly-spun, reverse-osmosis membrane, and hollow-fiber membrane, among others.

The manifold 224 can be constructed using typical manufacturing techniques such as machining, molding, and casting of materials, e.g., aluminum and plastics. These materials are generally related to consumer goods and devices and therefore selection is often dictated by factors such as cost and reliability. For appliances such as water dispensers, materials are also non-toxic and inert, thereby providing consumable fluid, e.g., drinking water, to an end user. Other components of the appliance 200 such as those found in the fluid transport system 208 can include tubing comprising plastic and copper or other materials that are compatible with fluid flow and consumable fluid technology. Valves and other fittings and couplings are also used where appropriate to regulate and fluidly couple each of the fluid inlet 204, the fluid outlet 206, and the fluid treatment assembly 210.

In one embodiment, in lieu of the treatment cartridge 222 and the cartridge interface 226, the manifold 224 incorporates areas for both the cleaning solution and the filtering medium. These areas include features such as built-in or assembled components that can retain, hold, or otherwise secure the cleaning solution and the filtering medium in the manifold 224. Features such as a reservoir for the cleaning solution and tubing and valves are useful to direct and/or re-direct the fluid from the inlet side 230 to the outlet side 232 via one or more of the cleaning solution and the filtering medium. The manifold 224 is also configured to provide access to the cleaning solution and the filtering medium such as by way of a cap, lid, access port, or other device that permits an end user to expose the reservoir or the filtering medium or other parts of the manifold 224 for implementation of the cleaning solution and the filtering medium therein.

Features such as the areas discussed above are illustrated in more detail in FIG. 3, in which there is depicted another exemplary embodiment of an appliance 300. Like numerals are used to identify like components as between FIG. 2 and FIG. 3, but the numerals are increased (e.g., 200 in FIG. 2 is 300 in FIG. 3). For example, the appliance 300 is coupled to a fluid supply 302, and includes a fluid inlet 304, a fluid outlet 306, and a fluid transport system 308, which includes a fluid treatment assembly 310.

The fluid treatment assembly 310 includes a manifold 324, with an inlet side 330 and an outlet side 332, and a fluid passage 334 with an inlet portion 340 and an outlet portion 342. Coupled to the fluid passage 334 is at least one area 356 that is interchangeable between the sanitizing media and the filtering media described herein. The area 356 in the present example comprises a filtering or first area 358 and a sanitizing or second area 360, each being configured to hold, respectively, a filtering media 362 and a sanitizing media 364. A lid (not shown) can be provided, disposed in one example on the manifold 324, for access to the area 356 such as to replace and/or replenish one or more of the filtering media 362 and the sanitizing media 364.

In one embodiment, the appliance 300 further comprises a flow diverting device 368 such as a valve, which is included in the manifold 324, a sanitizing conduit 372, a filtering conduit 374, and a pair of check valves 376. The flow diverting device 368 is configured to receive fluid from the inlet side 334 and to divert the fluid to one or both of the filtering conduit 370 and the sanitizing conduit 372. In one example, the filtering conduit 370 is coupled to the filtering area 358 so the fluid is exposed to the filtering media 362 before it exits the manifold 324 and is dispensed to the end user. The sanitizing conduit 372 is coupled to the sanitizing area 360, thereby permitting the fluid to mix with and disperse the sanitizing media 364 throughout the appliance 300 as contemplated herein. The check valves 376 are provided so as to prevent the fluid from entering into the one or more of the filtering area 358 and the sanitizing area 360 and vice versa. To illustrate, when the fluid is diverted to the filtering media 362, the check valves 376 are configured to permit the fluid to exit the filtering media 362 but does not permit the fluid to enter into the area 362 that retains the sanitizing media 364.

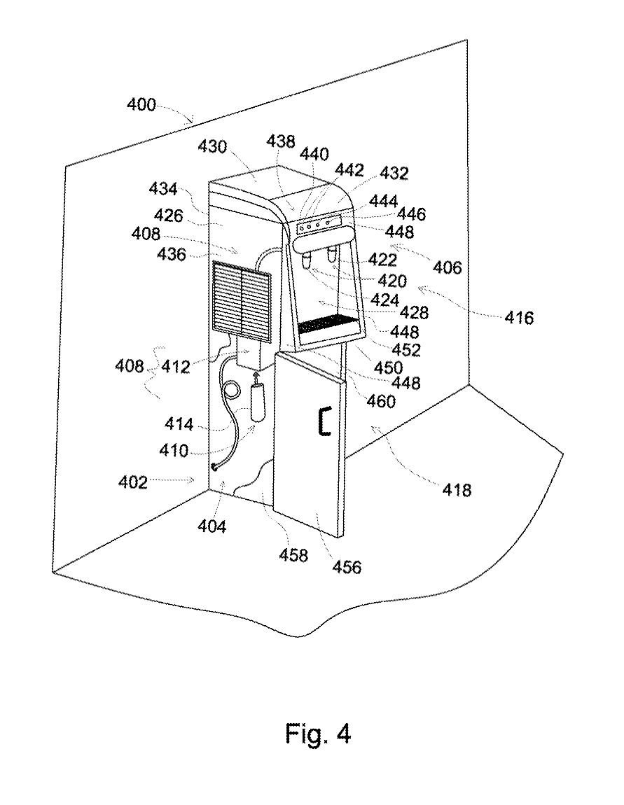

FIG. 4 illustrates a water dispenser 400 in which the concepts of the present disclosure may be practiced. It is recognized, however, that the benefits of these concepts apply to other types of appliances configured for dispensing a fluid to an end user. Consequently, the description set forth herein is for illustrative purposes only and is not intended to limit the invention to practice with a particular appliance, such as appliance 400.

As depicted in FIG. 4 the appliance 400 is coupled to a fluid supply, generally indicated by the numeral 402. The appliance 400 includes a fluid inlet 404, a fluid outlet 406, and a fluid transport system 408 comprising tubes, connectors, fittings, and related components consistent with the appliances (e.g., the appliance 100, 200, and 300) discussed herein. The appliance 400 also includes a treatment cartridge 410 and a manifold 412, wherein the treatment cartridge 410 is configured as a vessel 414.

The appliance 400 is constructed with a fluid dispenser assembly 416 and a lower compartment assembly 418. In the exemplary embodiment, the fluid dispenser assembly 416 is positioned above the lower compartment assembly 418 and includes one or more fluid dispensers 420, which includes a first fluid dispenser 422 and a second fluid dispenser 424 that are arranged side-by-side. The fluid dispenser assembly 416 also includes an external housing 426 and an alcove housing 428. The external housing 426 includes a housing top 428, a front wall 430, a back wall 432, and a pair of side walls 434. The front wall 430 and the side walls 434 form a space into which the alcove housing 428 is inserted. In one embodiment, a control panel 436 is disposed proximate the alcove housing 428. The control panel 436 provides one or more end user controls 438 such as dispensing controls 440 for dispensing fluid from the first fluid dispenser 422 and the second fluid dispenser 424. The control panel 436 also includes a reset control 442 and an indicator 444 such as an LED or related lighting device for providing visual indication to the end user.

The alcove housing 428 includes walls 446 with a bottom wall 448. A drip receptacle 450 rests on the bottom wall 452. In one embodiment, the first fluid dispenser 422 and the second fluid dispenser 424 are positioned within alcove housing 428 generally directly above drip receptacle 450.

The lower compartment assembly 418 includes a door 454 and a lower housing 456, which defines a storage cavity 458. In one embodiment, the lower compartment assembly 418 is non-refrigerated. However, embodiments of the appliance 400 can be equipped so that the lower compartment assembly 418 is refrigerated, i.e., cooled to a desired temperature.

While appliance 400 could be utilized without an heating or cooling apparatus, commercial units typically include at least a cooling unit, both heating and cooling units, or heating, cooling and room temperature units. When two faucets are used, i.e., one faucet is configured dispensing cold water and one faucet is configured for dispensing room temperature water, this is known as a “cool and cold” unit; if one faucet dispenses cold water and the other dispense hot water, this is known as a “hot and cold” unit. Embodiments of the appliance 400 may be a countertop model or floor model, the latter configuration. i.e. the floor model, being depicted in FIG. 4. As mentioned above, appliances such as appliances 100, 200, 300, and 400 may also comprise refrigerators that include a water dispenser, e.g., in the door of the refrigerator.

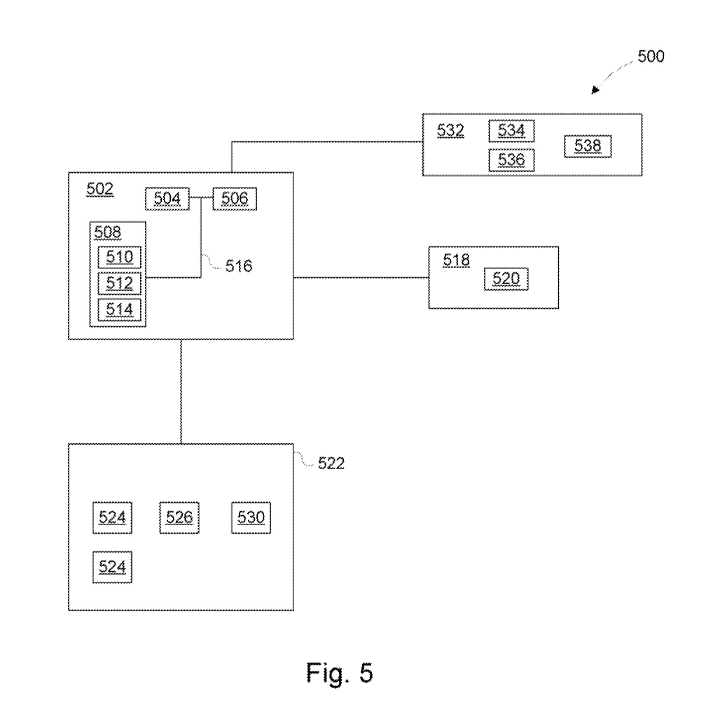

A variety of control configurations and schemes can be used to implement operation of these appliances, thereby facilitating sanitization and cleaning of the appliances discussed above. The example in FIG. 5 provides a schematic diagram of one configuration of an exemplary control scheme 500 for use in, e.g., the appliances 100, 200, 300, and 400, and related embodiments (“the fluid dispensing appliances”). The control scheme 500 includes a controller 502, which includes a processor 504, a memory 506, and control circuitry 508 configured for general operation of the fluid dispensing appliances. The control circuitry 508 comprises a timing circuit 510, a sensor interface circuit 512, and a valve interface circuit 514. All of these components are coupled together and communicate to one another when applicable via one or more busses 516. Also illustrated in the control scheme 500 is a flow control device 518, which includes one or more valves 520 that control the flow of fluid in the fluid dispensing appliance.

In one embodiment, the controller 502 is coupled to a control panel 522 (e.g., the control panel 436 (FIG. 4)). The control panel 522 includes one or more dispense controls 524, a reset control 526, and an indicator control 528. The control scheme 500 further includes a temperature control 532, with one or more temperature sensors 534 and 536 and a heating/cooling assembly 538, the combination of which is useful to regulate the temperature of the fluid (e.g., dispensed hot fluid) and the temperature of refrigerated compartments of the fluid dispensing appliance.

When implemented in the fluid dispensing appliances, the controller 502 effectuates operation of various elements of the appliance such as in response to inputs from the control panel 522. The timing circuit 510, of which various configurations are contemplated, is provided to indicate times and time periods to, e.g., change the configuration of the appliance as between the filtering configuration and the sanitation configuration. These time periods may be selected, in connection with or wholly separate from the configuration of the fluid dispensing appliance, to improve the cleanliness and sanitation of the appliances as contemplated herein. Timing selections can in one example be implemented on a periodic basis, such as weekly or monthly, as well as in connection with other indicators such as replacement of the filter.

At a high level, configurations of the controller 502 include one or more groups of electrical circuits that are each configured to operate, separately or in conjunction with other electrical circuits, to operate of the fluid dispensing appliances. The controller 502 and its constructive components are configured to communicate amongst themselves and/or with other circuits (and/or devices), which execute high-level logic functions, algorithms, as well as firmware and software instructions. Exemplary circuits of this type include, but are not limited to, discrete elements such as resistors, transistors, diodes, switches, and capacitors, as well as microprocessors and other logic devices such as field programmable gate arrays (“FPGAs”) and application specific integrated circuits (“ASICs”). While all of the discrete elements, circuits, and devices function individually in a manner that is generally understood by those artisans that have ordinary skill in the electrical arts, it is their combination and integration into functional electrical groups and circuits that generally provide for the concepts that are disclosed and described herein.

The electrical circuits of the controller 502 are sometimes implemented in a manner that can physically manifest logical operations, which are useful to facilitate the timing of the configuration change of the fluid dispensing appliance. These electrical circuits can replicate in physical form an algorithm, a comparative analysis, and/or a decisional logic tree, each of which operates to assign an output and/or a value to the output such as to activate the indicator control 530 and/or to actuate the valve 520.

In one embodiment, the processor 504 is a central processing unit (CPU) such as an ASIC and/or an FPGA. The processor 504 can also include state machine circuitry or other suitable components capable of receiving inputs from, e.g. the control panel 522. The memory 506 includes volatile and non-volatile memory and can be used for storage of software (or firmware) instructions and configuration settings. Each of the timing circuit 510, the sensor interface circuit 512, and the valve interface circuit 514 can be embodied as stand-alone devices such as solid-state devices. These devices can be mounted to substrates such as printed-circuit boards, which can accommodate various components including the processor 504, the memory 506, and other related circuitry to facilitate operation of the controller 502 in connection with its implementation in the fluid dispensing appliances.

However, although FIG. 5 shows the processor 504, the memory 506, the timing circuit 510, the sensor interface circuit 512, and the valve interface circuit 514 as discrete circuitry and combinations of discrete components, this need not be the case. For example, one or more of these components can be contained in a single integrated circuit (IC) or other component. As another example, the processor 504 can include internal program memory such as RAM and/or ROM. Similarly, any one or more of functions of these components can be distributed across additional components (e.g. multiple processors or other components).

In view of the foregoing, and with continued reference to FIGS. 1-5, in one embodiment, the appliance (e.g., the appliances 100, 200, 300, and 400) is configurable as between the sanitation configuration and the filtering configuration. With particular reference to the appliance 400 of FIG. 4, the treatment cartridge 410 is interchangeable on the manifold 412 such as by rotating the treatment cartridge 410 to release and/or engage the treatment cartridge 410 with the manifold 412. By way of example, but not limitation, the appliance 400 is configured so as to activate the indicator 444 when sanitation of the appliance 400 is required. While the triggers for activation of the indicator 444 can vary, it is contemplated that such triggers include a time period between implementation of the sanitation configuration and/or a measure of the build-up of impurities as indicated by, e.g., a sensor that monitors impurities in the fluid.

In response to the indicator 444, the end user can remove a first treatment cartridge from the manifold 412, the first treatment cartridge being outfitted with a filtering media. The end user can prepare a second treatment cartridge with a sanitizing media such as a bleach and water solution of appropriate proportion including, but not limited to, about 1 parts bleach to about 1 parts water (for typical household bleach of 6% maximum concentration and a contact period during the sanitation configuration of about 20 minutes). However, the inventors recognize that such ratios can vary and thus the concepts of the present disclosure can accommodate a wide range of products and materials and different levels of concentrations and ratios.

The second treatment cartridge is thereafter engaged with the cartridge interface (e.g., the cartridge interface 226 (FIG. 2)) such as by rotating the second treatment cartridge. Installation of the second treatment cartridge exposes the sanitizing media to the fluid. In one example, the appliance 400 is configured to automatically till the second treatment cartridge when the second treatment cartridge is seated in the cartridge interface (e.g., the cartridge interface 226 (FIG. 2)). In another example, the end user actuates one or more of the dispensing controls 440 to permit fluid to flow into the second treatment cartridge. The flow of the fluid dilutes the sanitizing media and carries the diluted sanitizing media throughout the fluid transport system 408.

Some of these steps may be automated such as by way of the control scheme 500 and/or other circuitry that executes instructions (e.g., firmware and/or software). These instructions may provide an alert (e.g., an audible alarm and/or a visual indication) to prompt the change in configuration of the appliance from the filtering configuration to the sanitation configuration. This change may occur automatedly or automatically, wherein the cleaning solution is dispensed or operation of the appliance is prevented until cleaning processes are implemented.

Automation of one or more of the concepts above, such as for automatically changing the configuration of the appliance, may require additional components and features not necessarily discussed above. In one embodiment, the appliance may incorporate a drain and/or waste water reservoir in which can flow the cleaning solution during implementation of the sanitation configuration. The drain can be coupled to an exterior receptacle, and in one construction the drain is coupled to the sanitation system (e.g., the waste water system) of a home or office. When a waste water reservoir is utilized, the automated instructions may include a prompt or other indication to the end user that sanitation is complete, thereby signaling the end user in one example to empty the waste water reservoir. Appropriate prompts and indicators can vary, with examples including, but not limited to expiration of a time period to permit the fluid to drain out of the waste water reservoir, a fluid level sensor that monitors the level of fluid in the waste water reservoir, and the like.

In another embodiment, configurations of the appliance for automated processes may likewise comprise features that prevent and/or discourage use of the water dispenser, such as to dispense water for consumption by the end, until such time that the sanitation media is flushed and/or removed from the appliance or, in another example, diluted to a level at which the end user can consume the water that is dispensed therefrom. These features may include a valve or similar locking mechanism that stops the flow of fluid to the dispensing area of the appliance. In one example, a solenoid valve may be actuated to a first position prior to, or contemporaneously with, the change to the sanitation configuration. This first position will inhibit the flow of fluid to the fluid dispensers (e.g., the fluid dispensers 422, 424 (FIG. 4) from which water is released to the end user, thereby reducing the likelihood that the end user will accidentally consume any of the cleaning solution. In one example, after a pre-set time, a second solenoid valve can divert cleaning solution to drain and begin flushing operation until solution is removed or adequately diluted. Once completion of sanitation and the flushing operation, the solenoid valve can actuate to a second position, which in one construction is an open position that permits fluid to flow to the fluid dispensers for dispensing by the end user.

Where applicable it is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

This written description uses examples to disclose embodiments of the invention, including the best mode, and also to enable any person skilled in the art to practice the invention, including making and using any devices or systems and performing any incorporated methods. The patentable scope of the invention is defied by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An appliance for dispensing a fluid, said appliance comprising:
a fluid inlet;
a fluid outlet coupled to the fluid inlet; and
a fluid treatment assembly in fluid communication with the fluid inlet and the fluid outlet, the fluid treatment assembly comprising an interface,
wherein the interface is configured to receive a treatment media, and
wherein the treatment media is interchangeable between at least one of a sanitizing media and a filtering media.

2. An appliance according to claim 1, further comprising a treatment element having the treatment media stored therein, wherein the treatment element is configured to engage the interface so as to place the treatment media in fluid communication with the fluid inlet and the fluid outlet.

3. An appliance according to claim 2, wherein the treatment element is removeable from the interface.

4. An appliance according to claim 2, wherein the treatment element is incorporated into the interface

5. An appliance according to claim 1, wherein the sanitizing media is dilutable in the fluid.

6. An appliance according to claim 1, further comprising a manifold coupled to the interface, wherein the manifold includes a first opening upstream of the treatment element, a second opening downstream of the treatment element, and a fluid passageway that couples each of the first opening, the second opening, and the interface.

7. An appliance having a fluid inlet, a fluid outlet, and a fluid transport system communicating a fluid between the fluid inlet and the fluid outlet, said appliance comprising:
a manifold; and
a cartridge interface coupled to the manifold,
wherein the cartridge interface is interchangeable between a sanitation configuration and a filtering configuration.

8. An appliance according to claim 7, further comprising a vessel having an interior cavity, wherein the vessel is configured to engage the cartridge interface to expose the interior cavity to the fluid inlet and the fluid outlet.

9. An appliance according to claim 8, wherein a treatment media is disposed in the interior cavity.

10. An appliance according to claim 7, wherein each of the sanitation configuration and the filtering configuration are effectuated by the same cartridge interface.

11. An appliance according to claim 7, wherein the cartridge interface is configured to receive a treatment media, and wherein the treatment media is interchangeable between a sanitizing media and a filtering media.

12. An appliance according to claim 7, wherein the fluid inlet is configured to receive fluid from a water bottle.

13. An appliance according to claim 7, wherein the fluid inlet is configured to receive fluid from a municipal water supply.

14. An appliance according to claim 7, wherein the cartridge interface comprises a twist-and-lock feature.

15. An appliance according to claim 7, wherein the cartridge interface is configured to expose a sanitizing media to the fluid in the sanitation configuration.

16. An appliance according to claim 7, further comprising a controller, wherein the controller is configured to change the filtering configuration to the sanitation configuration.

17. An appliance according to claim 16, wherein the manifold is configured for a cleaning solution that comprises bleach and which is dispensed from the manifold in the sanitation configuration.

18. An appliance according to claim 17, wherein the controller is further configured to implemented a flushing operation in which the cleaning solution is purged through a drain.
